(19) United States
(12) Patent Application Publication
(10) Pub. No.: US 2014/0074610 A1
(43) Pub. Date: Mar. 13, 2014

(54) GENERATING A POINT OF INTEREST PROFILE BASED ON THIRD-PARTY SOCIAL COMMENTS

(71) Applicant: QUALCOMM INCORPORATED, San Diego, CA (US)

(72) Inventor: Eric Bilange, San Diego, CA (US)

(73) Assignee: QUALCOMM INCORPORATED, San Diego, CA (US)

(21) Appl. No.: 13/773,929

(22) Filed: Feb. 22, 2013

Related U.S. Application Data
(60) Provisional application No. 61/700,670, filed on Sep. 13, 2012.

(51) Int. Cl. G06Q 30/02; G06Q 50/00

(52) U.S. Cl. CPC G06Q 30/0261; G06Q 50/01
USPC 705/14.58

(57) ABSTRACT

Methods, systems and devices for generating a point of interest profile of a target user. Aspects include querying a web site for at least one social comment associated with a point of interest visited by the target user. The at least one social comment may be posted to the web site by at least one third-party not affiliated with the point of interest. The at least one social comment may be parsed for at least one keyword contained therein. Also, the at least one keyword may be correlated to an attribute characterizing visitors of the point of interest. A point of interest profile associating the attribute with the target user may additionally be generated. Further, the determined attribute may be associated with at least one third-party and the point of interest.

### RELATED APPLICATIONS

This application claims the benefit of priority to U.S. Provisional Application No. 61/700,670 entitled “Deriving Profile Attribute From Real World Activity Using Social Qualification of Points of Interest,” filed Sep. 13, 2012, the entire contents of which are hereby incorporated by reference.

### BACKGROUND

Many techniques are employed to accurately identify a profile of the day-to-day activities of people, particularly consumers. Some systems rely upon how people use the internet, including sites most frequented, how much time and money is spent on those sites, as well as when such online activity occurs. Additionally, profile information may be obtained from publicly available census-type information, such as geo-political, occupational, gender or even marital profiling information. However, real profiles are based on more than just how people surf the web. Also, census-type information only reflects a general trend or stereotype and often does not accurately reflects the interests and past-times of numerous individuals that fall within the group associated with the stereotype. Thus, some profiling techniques use payment network activity to infer further profiling attributes. As someone travels outside their home and makes purchases, particularly using credit cards, such purchases provide indications of real world activity. However, such payment networks will not reflect when someone visits a location but does not spend their own money. For example, someone may visit a Chinese food restaurant they very much enjoy, but are often invited as guests and do not pay the bill themselves or perhaps pay cash, thus not being tracked by the payment network.

Additionally, individuals that carry smartphones or other electronic devices with GPS or the ability to accurately determine location may compile further profiling information. Such devices may be used to determine the location of a user, including the particular business, institution or property being visited. With such a device, over time information may be collected showing the locations most frequented by a particular user. Such most frequented locations are referred to herein as points of interest (POI's). Thus, when a user with a smartphone goes to a particular restaurant a lot, it can be inferred that individual likes eating out and likes the food at that restaurant. Alternatively, a user that frequents a gym may have exercise associated with a profile of their interests. However, many locations are multi-purposed and thus a visitor's interests are less clear. For example, it may be unclear whether someone who visits a beach likes to swim, exercise, tan themselves, surf or build sand castles. Also, a location like a restaurant may advertise the type of cuisine they prepare and the décor or ambiance they present, but this fails to indicate other profiling information like the age group that most frequents the locale or that book-clubs prefer meeting there.

### SUMMARY

The various embodiments include a method of generating a point of interest profile of a target user. The method may include querying a web site for at least one social comment associated with a point of interest visited by the target user. The at least one social comment may be posted to the web site by at least one third-party not affiliated with the point of interest. Also, the method may parse the at least one social comment for at least one keyword contained therein, the at least one keyword may be correlated to an attribute characterizing visitors of the point of interest, and a point of interest profile associating the attribute with the target user may be generated.

A further embodiment may include a method of generating a point of interest profile that may include receiving an identifier indicating a point of interest visited by a target user. A third-party attribute associated with at least one third-party and the point of interest may be determined, wherein the third-party is not affiliated with the point of interest. Additionally, a point of interest profile associating the attribute with the target user may be generated.

Further embodiments may include a method of generating a point of interest profile that may include receiving an identifier indicating a point of interest visited by a target user. An attribute associated with at least one third-party and the point of interest may be determined in which the third-party is not affiliated with the point of interest. Also, a point of interest profile may be generated associating the attribute with the target user.

Further embodiments may include a computing device having a processor configured with processor-executable instructions to perform various operations corresponding to the methods discussed above.

Further embodiments may include a computing device having various means for performing functions corresponding to the method operations discussed above.

Further embodiments may include a non-transitory processor-readable storage medium having stored thereon processor-executable instructions configured to cause a processor to perform various operations corresponding to the method operations discussed above.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a system block diagram of a network suitable for use with the various embodiments.

FIG. 2 is a system block diagram of an alternative network suitable for use with the various embodiments.

FIG. 3 is a communication system block diagram of a network suitable for use with the various embodiments.

FIG. 4 is a process flow diagram illustrating an embodiment method for generating a point of interest profile.

FIG. 5 is a process flow diagram illustrating an alternative embodiment method for generating a point of interest profile.

FIG. 6 is a component diagram of a cellular communication device suitable for use with the various embodiments.

FIG. 7 is a component diagram of a wireless device suitable for use with the various embodiments.

FIG. 8 is a component diagram of another wireless device suitable for use with the various embodiments.

FIG. 9 is a component diagram of a server suitable for use with the various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

The word “exemplary” is used herein to mean “serving as an example, instance, or illustration.” Any implementation described herein as “exemplary” is not necessarily to be construed as preferred or advantageous over other implementations.

As used herein, the terms “communication device,” “wireless device,” and “mobile device” refer to any one or all of cellular telephones, smart phones, personal or mobile multi-media players, personal data assistants (PDA's), laptop computers, tablet computers, desktop computers, smart books, palm-top computers, wireless electronic mail receivers, multimedia Internet enabled cellular telephones, wireless gaming controllers, and similar personal electronic devices which include a programmable processor and memory and circuitry for modifying search terms.

The systems, methods, and devices of the various embodiments use location data to determine where a mobile device is located, and thus the locations and points of interest frequently visited by the user in order to develop a more complete user profile. The location of a user at any given time can be determined by automated techniques or may be manually entered by the user by registering their location upon arrival. Alternatively, location information may be determined from one or more other entities indicated as being in close-proximity to the user and having their location information confirmed.

As used herein, the term “location” refers to either a physical or virtual place with an identifiable name. Such locations generally attract people to visit there, whether they are physical locations or virtual ones. As used herein, the term “visit,” “visited” and/or “visiting” refers to going to see, stay and/or spend time at or at least in close proximity to a location or even going to a website or web page. Additionally, visitor or visitors refers to one or more individuals that visit a location, including not only a physical location but also a website or web page. Also, locations will generally have owners or proprietors interested in running or maintaining those locations. Those owners or proprietors, as well as their employees and agents, are considered to be directly affiliated with their respective location(s). As used herein, the terms “point of interest” or “POI” refers to a location which a user visits more than others, spends more time at than others, meets the most acquaintances or at which the user spends substantial amounts of money. Similarly, as used herein the term “identifier” when referring to a location refers to at least one name, address or other code/symbol used to identify a unique location.

As used herein, the term “user” refers to a principal subject of the point of interest analysis for whom one or more attributes is being compiled and a user profile generated. Also, as used herein, the term “entity” refers to a person, partnership, organization or business that has an identifiable existence. Additionally, as used herein, the term “third-party” refers to an entity that is neither the user nor affiliated with a particular location. Thus, as relating to a location, a third-party is not officially attached or connected to the location or an entity that owns, operates or controls the location.

The various embodiments include methods, system and devices for building-on and/or enhancing a basic user profile in order to provide a more complete picture of a user's interests, habits and day-to-day activities based upon social comments associated with locations of interest to the user. Locations of interest may be chosen by the system based on various factors, including the duration/frequency of the user's visits or by the potential commercial or research interest in a location. In an embodiment relating identifying such points of interest frequented by the user, a point of interest may be a physical location, such a restaurant, tavern, theatre, park, etc. or a virtual location such as a web-site frequently visited by the user. Also, a point of interest may be a web-site, whether or not it is associated with a physical location, and thus may be an entirely virtual location.

Initially, the identification of points of interest may be accomplished by various means. In the case of physical locations, a user's visits to such locations must be tracked. Various embodiments take advantage of existing location awareness technologies, such as Gimbal™ (by Qualcomm Labs, Inc., San Diego, Calif.), which use an individual's smartphone to determine their physical location. In fact, such systems are able to detect and track the user's most frequently visited locations (such as home, the office, the gym, school, etc.) by clustering location fixes and mapping them to a list of points of interest in order to improve the identification of the real location of the user, as well as their POI's, based on the user's tracked travel habits. In the various embodiments, current state information, historical data, and expected location predictions may be used together to locate the user. Based on that determination of individual locations and times, a POI list may be determined and used for generating a user profile.

In the case of virtual locations that are points of interest to a user, the identification of that location is more easily obtained. Using tracking cookies or other web history tracking methods, a user's on-line points of interest may be identified along with the time and duration of visits to such sites. To the extent possible, both physical and virtual points of interest may be identified for a particular user. Also, sometimes virtual locations are in some way related to or affiliated with a physical location. For example, a restaurant or retail store may have its own official web site or a dedicated page/forum on a shared web site. Alternatively, the web site may provide information about one or more physical locations, and thus is considered for point of interest purposes to be related to each of those locations, but is not actually affiliated with those locations.

Another embodiment relates to obtaining social comments regarding the identified point of interest. Such social comments may be obtained from one or more existing feeds associated with a point of interest, such as on-line social networks. Any obtained social comment associated with the location of interest is scanned for keywords that may be correlated to one or more attributes associated with people who frequent that location. Once one or more such keywords are identified through the social comments related to the location, the attribute may be added to the user's profile to generate a point of interest profile pertinent to a target user.

The various embodiments use data, associated with locations, that is maintained on web sites in the form of social comments. As used herein, the terms “web site” refers to one or more pages on the Internet regarded as a single non-living entity, usually maintained to document information or the exchange thereof regarding one topic or closely related topics. In an embodiment, the social comments is collected from existing website feeds of such data obtained through social network web sites like Facebook®, Yelp®, Foursquare® and Twitter®. For example, an individual user may like a restaurant named Burlap, which is located in Del Mar, Calif. While the official restaurant web site for Burlap may describe its cuisine as Asian fusion and tout its accolades, it doesn't tell you much about the customers that frequent the establishment. In contrast, other web sites like Yelp maintain commentary about such places. Third-parties post comments like “ . . . great drinks and lots of good looking people, but . . . ,” “The atmosphere is like a trendy club,” or “Just another trendy restaurant where everyone comes ‘dressed to impress’.” These types of commentary contain various keywords that may be associated with “attributes” of people who frequent that location or attributes of the location itself. As used herein, the term “attribute” refers to a quality or feature regarded as a characteristic or inherent part of someone or something. Thus, words like “trendy,” “drinks” or “club” may reflect attributes of Burlap's customers. In the various embodiments, such attributes may be associated with a user identified as including Burlap as one of his points of interest. In this way, the user's profile is enhanced to reflect further attributes, which may be used by marketers and/or researchers. It should be noted that the date and/or time comments were made, as well as date or time indications in comments are also considered as being part of attributes (for example, a restaurant may receive different comments for Tuesdays than other days of the week because it hosts special events, like Salsa lessons).

As used herein, the term “social comment” refers to one or more web postings intended as an explanation, illustration, criticism or praise on a subject. The social comment may include annotations, explanations, statements of fact or opinion and/or remarks that express a personal reaction or attitude. Also, as used herein the term “posting” or “posted” refers to an electronic message that is conveyed, transmitted or sent to a web site for others to view.

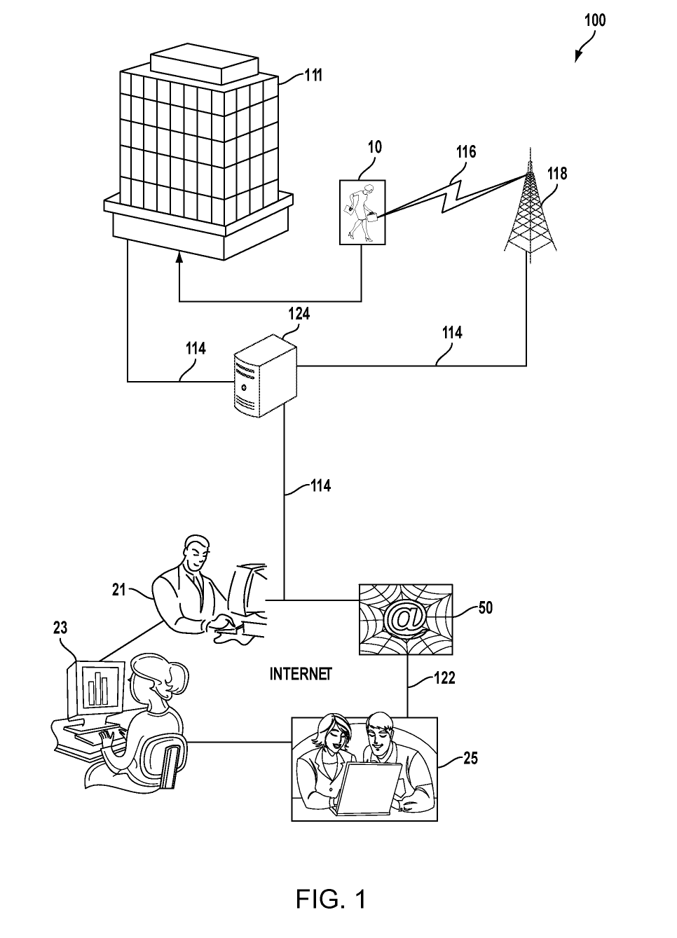

FIG. 1 illustrates an embodiment system in which a point of interest profile development system 100 tracks the physical places a user 10 visits. One such location 111 is illustrated as an office building, but the location 111 may be almost any destination visited by the user 10. Also, the location 111 may be more precisely defined than just the entire building and may identify a particular business within that building. During the user's visit at the location 111, a communication device carried by the user 10 may determine location information, which is communicated to a server 124 that compiles and maintains user profile data. In particular, when the user visits the location 111, the system 100 seeks to determine a location name or other identifier corresponding to geographic coordinates or other means of determining a location. Preferably the location is identified by a name, such as “The California Tower” or the nearby “San Diego Zoo.”

In an embodiment, the user's smart phone may be configured to determine the smart phone's current location using a navigation system receiver, such as a Global Positioning System (“GPS”) receiver. The GPS receiver can determine or assist in determining a current location by using geographic coordinates, such as a latitude and longitude. Those geographic coordinates may be compared to point of interest information available either to the smart phone processor, to a connected server 124 or elsewhere on the internet 122. In this way, the user's smart phone is employed to identify the location a user is visiting. The server 124 may maintain user profile data that is enhanced by the embodiments. A user may be provided an option whether to authorize the system to generate or enhance user profiles and particularly the point of interest profile described herein.

Alternatively, the smart phone might determine its location through proximity to a cellular tower 118 and its cellular connection 116 therewith. The cellular tower 118 may included a wired connection 114 to a server 124 or other computer network, or communicate to other cellular towers or communications stations that themselves have connections to the Internet 122. As a further alternative, the smart phone may determine its location through a wireless connection, such as Wi-Fi, provided at the location 111, which in-turn has its own wired connection 114 to a server 124 and/or the Internet 122. In these localized ways the mobile communication device communicates with a local communication device in the neighborhood of or associated with the point of interest, when the mobile communication device comes in proximity with the local communication device.

A point of interest for a particular user may be distinguished from just any location visited by the user in that the points of interest correspond to those locations identified as being most pertinent to the user. This determination of pertinence may be made based on various factors, such as how often and when the user visits the location, how long the user visits the location, how many other people the user meets at the location, how much commercial value the location has to vendors or proprietors of the location and other factors. In this way, the points of interest for a user may be limited to a certain quantity of locations with the highest determination of pertinence or simply most visited by the user. For example, the top 10 or 20 most frequented locations for a user may be designated as her points of interest. Alternatively, a threshold number of visits to a location may define whether it is a point of interest or not. Thus, the system need not consider associating attributes from a particular location to a user unless they visit the location a plurality of times greater than that preselected threshold number of visits.

Once an identifier is received or obtained for a location 111 determined to be a point of interest for the user, the system will query a web site for social comments regarding the location 111. Querying a web site is a mechanism for retrieving information from one or more databases maintained in connection with that web site. A query includes questions presented to the web site and/or directly to the one or more databases in a predefined format. One example of such format is the Structured Query Language (SQL). Such a query may be initiated from a server 124 or related equipment. The server 124, having a wired connection 114 or other connection to the Internet 122 may either transmit the request to a social networking web site 50 or access the social networking web site 50 for obtaining the requested social comments. The social networking web site 50 should include social comments, particularly social comments regarding the identified location 111. The requested social comments are ones previously posted to the web site 50 by third-party individuals 21, 23, 25, not affiliated with the point of interest and preferably not comments posted by the user 10, herself. If no social comments or insufficient social comments are available from the web site 50, then the user profile may remain unchanged or other methods used to enhance the profile. However, if social comments are received or otherwise obtained from the web site, the system may parse the social comments for keywords that may be correlated to a user attribute. Alternatively, in order to ensure the social comments more accurately reflect attributes of visitors to that location, the system need not associate attributes with a particular user unless a threshold quantity of third-parties have posted social comments about the location or a threshold number of common keywords are found among the social comments.

Keyword extraction may use NLP, Stochastic and Bayesian models of language such as Alchemy, GNU Libextractor, TerMine, TrM Extractor, etc. Also, keywords may be grouped by synonyms and/or manually associated to attributes.

A list of keywords may be maintained in a database, along with the one or more attributes correlated to each of those keywords. Correlating a keyword to an attribute, as used herein, refers to establishing a mutual relationship or connection between a keyword and an attribute. The correlation between keywords and attributes may be maintained in a database or performed at any time in accordance with the various embodiments herein. In this way, identified keywords will have a direct association with one or more attributes. Also, each attribute may have a direct association to one or more keywords. Thus, a target user's profile may be enhanced by adding attributes correlated to keywords to generate a point of interest profile. Examples of categories of point of interest attributes associated with a user may include age, sex, income, marital status, sexual preference, parental status, hobbies, entertainment interests and other interests. Additionally, within each category a set of attributes may be defined. For example, the age category may include attributes defined by words like “seniors,” “thirty-somethings,” “teens,” or even particular age ranges. Also, a particular attributes may fall into more than one category. Further, a group of keywords may be correlated to just one attribute. For example, “lively,” “wild” and “exciting” may be commonly associated and thus correlated to “partier.” Moreover, the at least one keyword may include more than one keyword. Additionally, one or more keywords may be given a higher level of significance than other keywords. The higher level of significance may represents input being received from a greater number of third-parties.

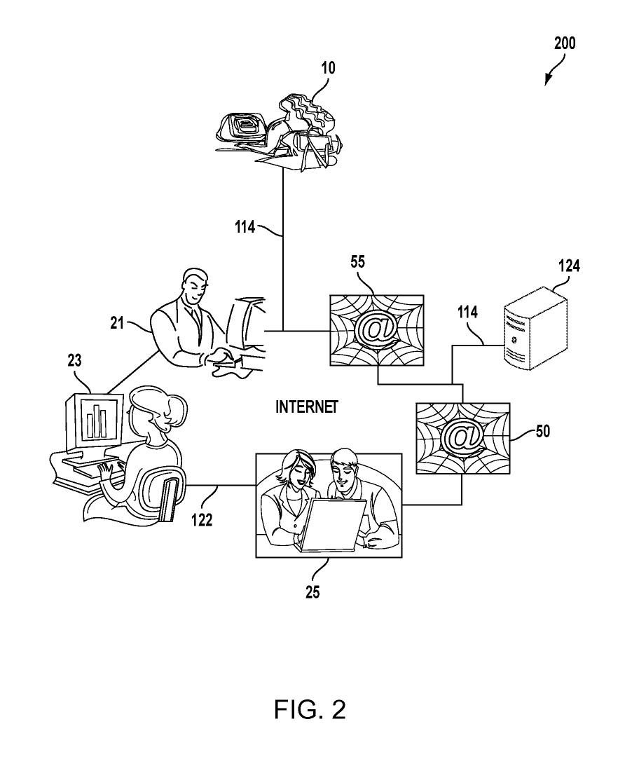

FIG. 2 illustrates an alternative point of interest profile development system 200 in accordance with an embodiment. This alternative system 200 is similar to the system 100 illustrated in FIG. 1, but rather than a physical location the point of interest is a further web page 55. In this embodiment, the user 10 surfs the Internet 122 using a wire connection 114 because her computer may not include wireless communication elements. However, it should be understood that this embodiment could alternatively include a wireless connection to the Internet 122. The web page 55 is identified as a point of interest, but the social comments regarding the web page 55 are still obtained from the social networking web site 50, the way they were with the system 100. In this way, attributes associated with keywords found in the social comments posted to web site 50 may be added to the profile of the user 10.

In an embodiment, a temporal indicator may be received along with the identifier indicating the point of interest. The temporal indicator represents a time of day and/or duration the user visited the point of interest. In this way, keywords may be correlated to the temporal indicator, so if many keywords found in social comments refer to the night time, but the user mainly visits the point of interest during the day, the system will know not to associate the related attribute(s) from those social comments.

Some points of interest will naturally emerge for the majority of users as their home and work. These specific locations may be excluded from profiling, particularly in cases when the individual works at a location about which people post comments. For example, if someone works at Burlap, the system need not associate the attributes inferred about Burlap from retail customers to that person. However, if other employees post social comments, the system may want to associate attributes correlated from keywords parsed from those social comments.

In another embodiment, a point of interest profile may be generated by determining one or more attributes from a second user whose user profile is associated with the subject point of interest. This alternative may be used separately, in combination with the social comment derived attributes described above or as an alternative when no social comments are received containing the at least one keyword.

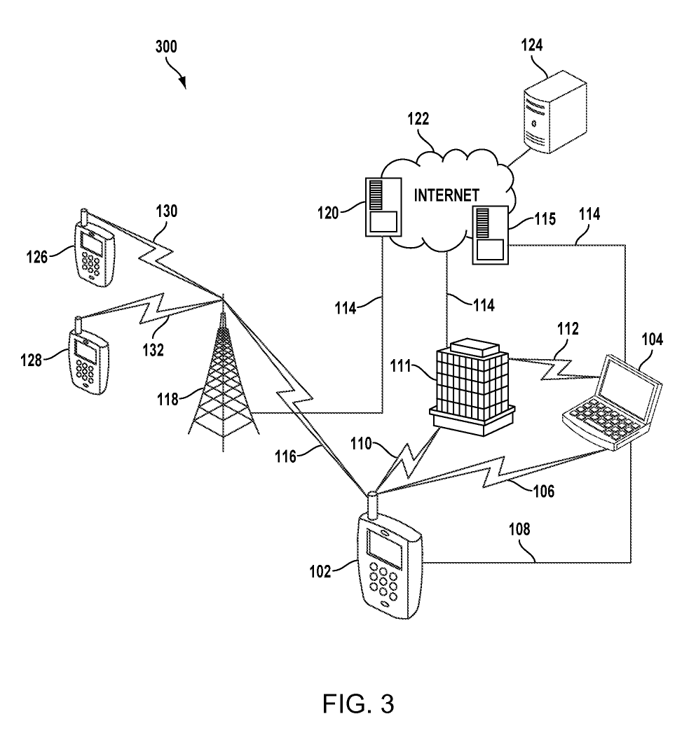

FIG. 3 illustrates a communication system 300 suitable for use with the various embodiments. The communication system 300 may include a first communication device, shown as a smart phone 102, second communication devices, shown as a laptop computer 104, additional communication devices shown as two further smart phones 126 and 128, and a server 124 connected to the Internet 122. The smart phone 102 may establish a wireless connection 110, with a location 111 having a wireless access point. Such a location 111 may be visited and frequented by the user of the smart phone 102. In this manner, data may be exchanged by the smart phone 102 via the Internet 122, as well as between the smart phone 102 and the server 124 via the Internet 122. Additionally, the smart phone 102 and a cellular tower or base station 118 may exchange data via a cellular connection 116, including CDMA, TDMA, GSM, PCS, 3G, 4G, LTE, or any other type connection. The cellular tower or base station 118 may be in communication with a router 120 which may connect to the Internet 122. In this manner, via the connections to the cellular tower or base station 118 and/or the Internet 122, data may be exchanged between the smart phone 102 and the server 124 as well as between the smart phone 102 and the laptop computer 104. Similarly, the laptop computer 104 may be in communication with a router 115 via a wired connection 114, and the router 115 may connect to the Internet 122. Additionally, the laptop computer 104 may establish a wireless connection 112, such as a Wi-Fi connection, with a location 111 having a Wi-Fi access point. The location 111 may be connected to the Internet 122. In this manner, via the connections to the location 111, router 115, and/or the Internet 122, data may be exchanged between the laptop computer 104 and the server 124. The laptop computer 104 may also establish a wireless connection 106, such as a Bluetooth® connection, with the smart phone 102 and/or a wired connection 108, such as a USB connection. In this manner, via the connection 106, 108, data may be exchanged between the laptop computer 104 and the smart phone 102.

The additional smart phones 126, 128 and a cellular tower or base station 118 may exchange data via a cellular connections 130, 132, respectively, including CDMA, TDMA, GSM, PCS, 3G, 4G, LTE, or any other type connection. In this manner via the connections to the cellular tower or base station 118 and/or the Internet 122, data may be exchanged between the smart phones 126, 128 and the laptop computer 104, server 124, and/or smart phone 102.

In an embodiment, the smart phone 102 and laptop computer 104 may be devices owned/operated by the same user, while smart phones 126, 128 may be owned/operated by different users. In an embodiment, smart phones 102, 126, 128 may be configured to determine their respective locations, for example using GPS receivers or potentially WiFi location services if available. Similarly, the laptop computer 104 may not be configured with GPS or cellular service and may need to rely upon an Ethernet connection, either wired or wireless.

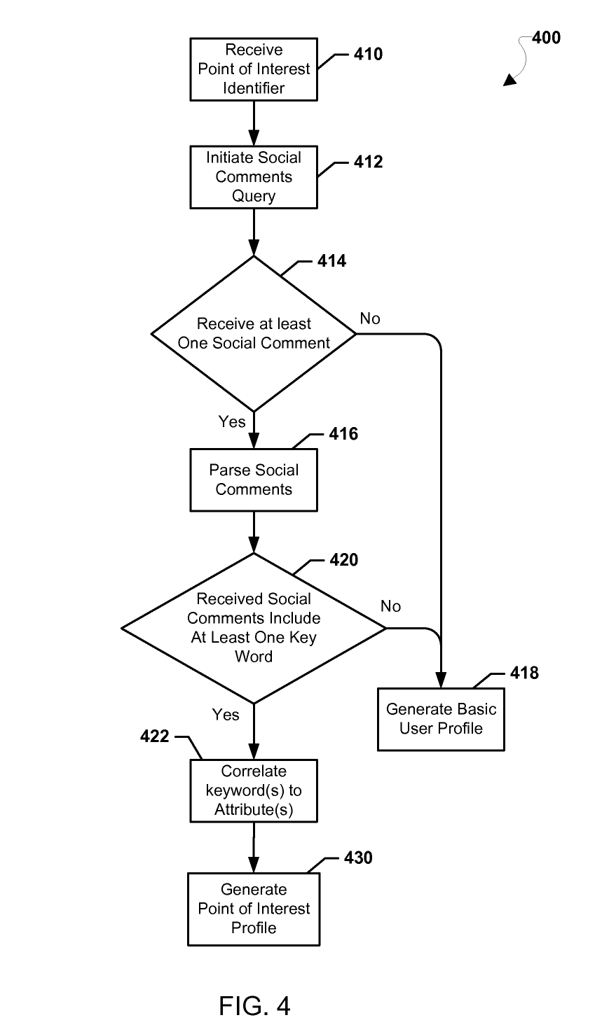

FIG. 4 illustrates an embodiment method 400 for generating a point of interest profile based on available social comments regarding a location. The operations of method 400 may be performed by a processor of a designated device. The designated device may be the user's own smart phone, or a separate computer/communication device made to implement the embodiment methods. In block 410 the designated device may receive an identifier which identifies and represents a point of interest location visited by the user. A point of interest is thus associated with a target user at block 410. Upon receipt of this identifier, in block 412 the device may initiate a request for social comments associated with the identified point of interest. The request may be initiated by transmitting the request to one or more web sites that maintain posted comments by others regarding the point of interest. Alternatively, the web site may regularly provide social comment information, updates or feeds to subscribers. Thus, the request 412 for social comments may even be initiated before a target user visits the point of interest or before the point of interest identifier is received and thus associated with a target user at 410. In block 414 a determination may be made as to whether at least one social comment is received or not. If at least one social comment is not received, a basic user profile may be generated or augmented at 418 without the enhanced attributes from user comments. Alternatively, if at least one social comment is received at determination block 414, then the social comment may be parsed at 416 in order to identify words contained therein. In particular, the parsed comments may be analyzed at 420 to determine whether they include at least one “keyword.” As noted above, a keyword may be one that may be correlated to one or many attributes applied to users that visit a location. If no keyword is included at 420, then once again a basic user profile may be generated at 418. If at least one keyword is included at 420, then a correlation may be made at 422 between keywords and one or more attributes. Thereafter, in block 430 a point of interest profile may be generated by adding to or altering (i.e., increasing) the weight of the one or more determined attributes to the subject user's profile. In another embodiment, the point of interest profile may include an accuracy rating associated with the location attribute based on a frequency the keyword is contained in the social comments or the frequency the attribute is associated with the point of interest. Thus, the point of interest profile may include an accuracy level indicator for the attribute. The accuracy level indicator may represent a statistical likelihood that the attribute is correctly associated with the user. Such a statistical likelihood may be determined based on the frequency a keyword is used in association with a location, the number of third-parties that use the keyword or similar indicators of accuracy.

In an alternative embodiment a point of interest profile may be generated using attributes of other users who frequent the same location. This alternative may be used when social comments are not available for a particular location, used in conjunction with social comment attributes or as a stand-alone technique. Consider, for example, 100 people recorded in a user database as having visited a beach. As part of maintaining that user database, profiles of those 100 people may be scanned for attributes. As with the earlier embodiment, such attributes may be derived from keywords identified in the user profiles. For example, that user profile database may include the attribute “has-kids” common to all or a significant number of those people. Using this commonality, the attribute “has-kids” may be added to a target user. In this example, the attribute may refer to a characteristic other than being a parent or guardian, such as someone who frequents that particular location or that type of location with children. This may identify the user as a parent or guardian, but also may identify them as a user that likes to visit that type of location bringing children along with them. Information of this type may be helpful to identify a more accurate profile of a target user's regular activity. Thus, this alternative method may be initiated to generate a point of interest profile by receiving an identifier indicating a point of interest visited by a user. The system may also determine an attribute associated with at least one other user (i.e., third party user) in connection with the point of interest who has visited the same point of interest. Additionally, a significant number of other users may be used to more accurately correlate the attribute with the target user. A point of interest profile may thus be generated associating the attribute determined in this way with the target user.

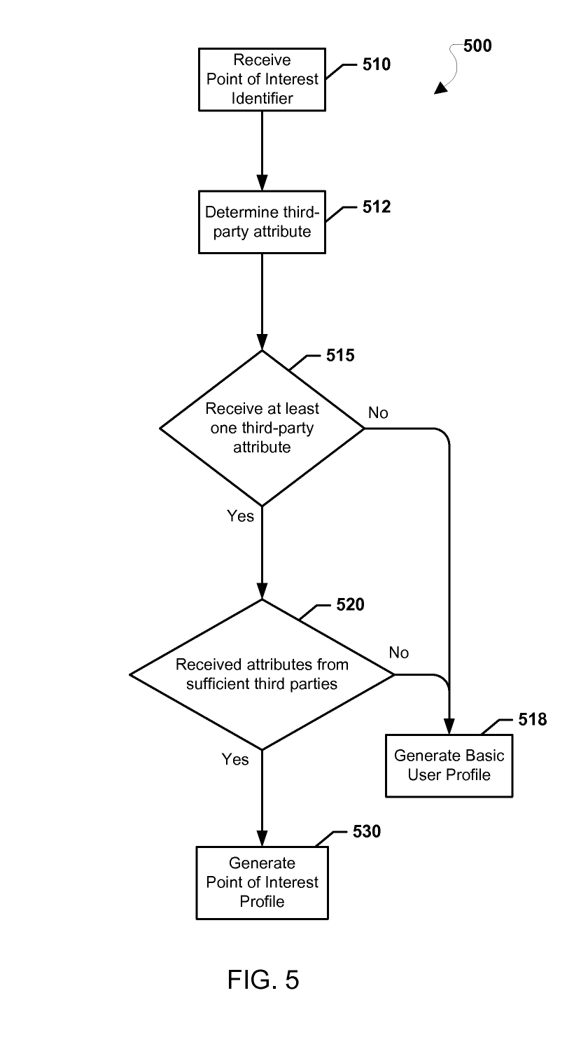

FIG. 5 illustrates an embodiment method 500 for generating a point of interest profile based on available third-party attributes associated with a particular location. The operations of method 500 may be performed by a processor of a designated device. The designated device may be the user's own smart phone, a server or other device. In block 510 the designated device may receive an identifier that represents a point of interest location visited by the user. In block 512 the device may determine a third-party attribute associated with at least one third-party and the identified point of interest. The determination in block 512 may be accomplished in various ways, including querying a third-party attribute database. Such a query may result in the determination of whether one or more third-party attributes are associated with the point of interest in question. The device may make that determination from its own internal memory or transmit a request/query for such information from a remote database. In determination block 515 the processor may determine whether a third-party attribute has been received. If the processor determines that a third-party attribute was not received (i.e., determination block 515=“No”), the processor may generate or augment a basic user profile in block 518 without the enhanced attributes from another (i.e., third-party) user. If it is determined in block 515 that a third-party attribute was not received (i.e., determination block 515=“Yes”), a determination in block 520 may be made as to whether a sufficient number of third-parties have an attribute for the location in question. The determination in block 520 may be based on whether a sufficient number of third-parties include a common enhanced attribute for a particular location, before adding that attribute to a target user's profile. A determination in block 520 may be made that an insufficient number of third-parties include a common attribute (i.e., determination block 520=“No”), in which case a basic user profile may be generated in block 518. Otherwise, if a sufficient number of third-parties include a common attribute (i.e., determination block 520=“Yes”), the processor may generate a point of interest profile in block 530, such as by adding an attribute or altering (i.e., increasing) the weight of the one or more determined attributes to the subject user's profile.

In the various embodiments, the point of interest profile may include an accuracy rating associated with the location attribute based on a frequency the attribute is associated with third-parties that visit the location. Thus, the point of interest profile may include an accuracy level indicator for the attribute. The accuracy level indicator may represent a statistical likelihood that the attribute is correctly associated with the user. Such a statistical likelihood may be determined based on the frequency that an attribute is used in association with a location, the number of third-parties that have that attribute associated with them or similar indicators of accuracy.

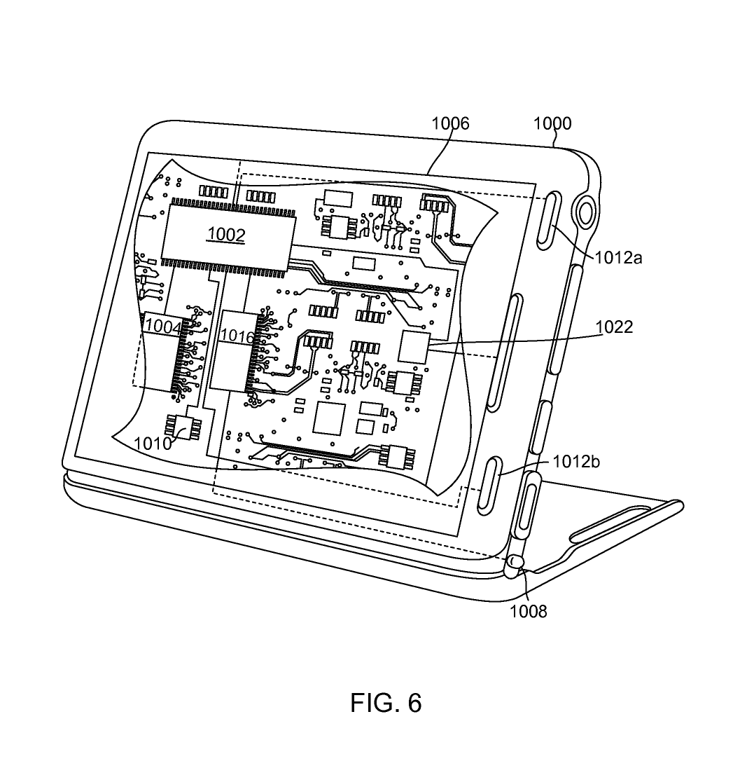

The various embodiments may be implemented in any of a variety of mobile communication devices, an example of which is illustrated in FIG. 6 in the form of a cellular telephone. Typical mobile communication devices 1000 will have in common the components illustrated in FIG. 6. For example, mobile communication devices 1000 may include a processor 1002 coupled to an internal memory 1004 and a touch surface input device/display 1006, such as a resistive sensing touchscreen, capacitive sensing touchscreen, infrared sensing touchscreen, acoustic/piezoelectric sensing touchscreen, or the like. The mobile communication device 1000 may have a radio/antenna 1008 for sending and receiving electromagnetic radiation that is connected to a wireless data link and/or cellular telephone transceiver 1016 coupled to the processor 1002. Mobile communication devices 1000 may also include a GPS receiver 1010 coupled to the processor 1002 for determining locations of the device. Mobile communication devices 1000 may also include physical buttons 1012a, 1012b for receiving user inputs.

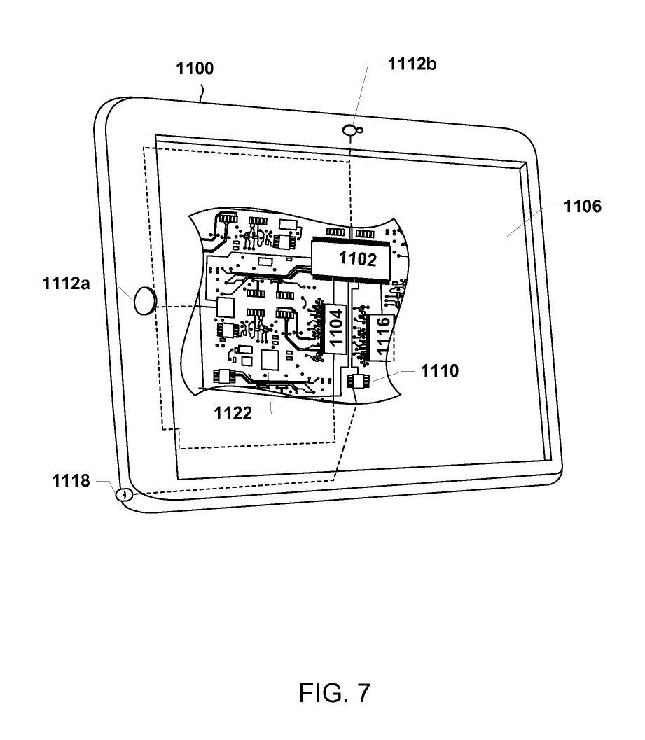

The various embodiments may be implemented in any of a variety of communication devices, an example of which is illustrated in FIG. 7. For example, the wireless device 1100 may include a processor 1102 coupled to internal memories 1104 and 1106. Internal memories 1104 and 1106 may be volatile or non-volatile memories, and may also be secure and/or encrypted memories, or unsecure and/or unencrypted memories, or any combination thereof. The processor 1102 may also be coupled to a user interface, such as a touch screen display 1106 (e.g., a resistive-sensing touch screen, capacitive-sensing touch screen infrared sensing touch screen, or the like), or conventional buttons (e.g., 1112a and 1112b) and a non-touch screen display. Additionally, the wireless device 1100 may include one or more network transceivers configured to enable the processor 1102 to communicate with other communication devices over one or more wired or wireless networks, such as the communication networks discussed above with reference to FIG. 3. As a particular example, the network transceivers of a wireless device 1100 may include one or more antenna for sending and receiving electromagnetic radiation that may be connected to one or more wireless data link transceiver and/or cellular telephone transceiver 1116 coupled to the processor 1102. The wireless device 1100 may also include physical buttons 1112a and 1112b for receiving user inputs. The wireless device 1100 may also include a power button 1118 for turning the wireless device 1100 on and off. The wireless device 1100 may also include a position sensor 1122, such as a GPS receiver, coupled to the processor 1102.

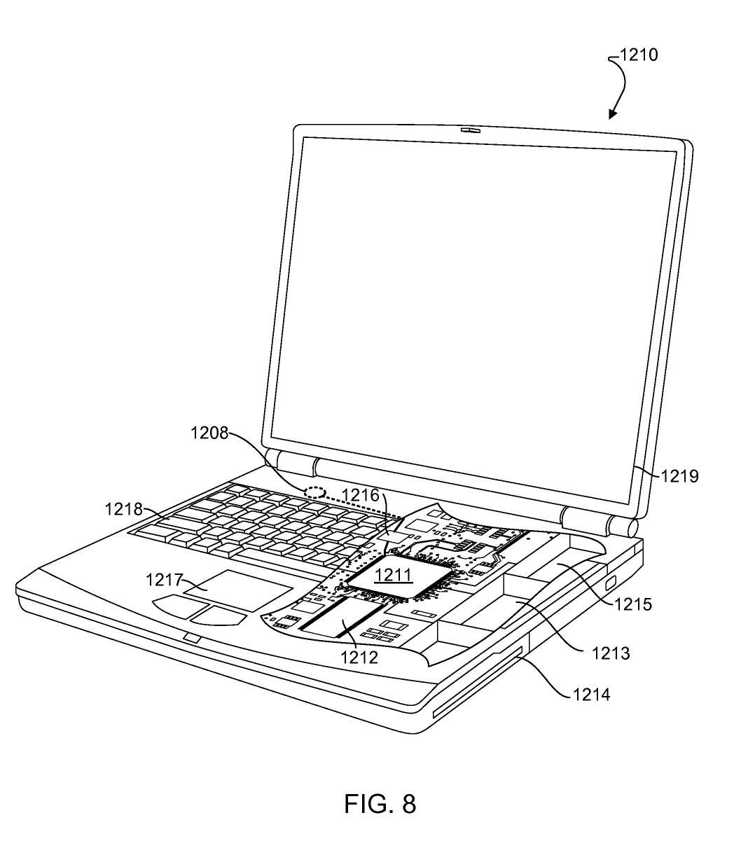

The various embodiments described above may also be implemented within a variety of personal communication devices, such as a laptop computer 1210 as illustrated in FIG. 8. Many laptop computers include a touch pad touch surface 1217 that serves as the computer's pointing device, and thus may receive drag, scroll, and flick gestures similar to those implemented on mobile communication devices equipped with a touch screen display and described above. A laptop computer 1210 will typically include a processor 1211 coupled to volatile memory 1212 and a large capacity nonvolatile memory, such as a disk drive 1213 of Flash memory. The laptop computer 1210 may also include a floppy disc drive 1214 and a compact disc (CD) drive 1215 coupled to the processor 1211. The laptop computer 1210 may also include a number of network transceivers or network connector ports coupled to the processor 1211 configured to enable the processor 1211 to communicate with other communication devices one or more wired or wireless networks, such as the communication networks discussed above with reference to FIG. 3. As a particular example, the network transceivers of a laptop computer 1210 may include Ethernet, USB or FireWire® connector sockets/transceivers, one or more wireless modem transceivers 1216, such as Wi-Fi and/or cellular data network transceivers, coupled to one or more antenna 1208 for sending and receiving electromagnetic radiation. The laptop computer 1210 may also include other types of network connection circuits for coupling the processor 1211 to a network that may be developed in the future. In a notebook configuration, the computer housing includes the touchpad 1217, the keyboard 1218, and the display 1219 all coupled to the processor 1211. Other configurations of the communication device may include a computer mouse or trackball coupled to the processor (e.g., via a USB input) as are well known, which may also be used in conjunction with the various embodiments.

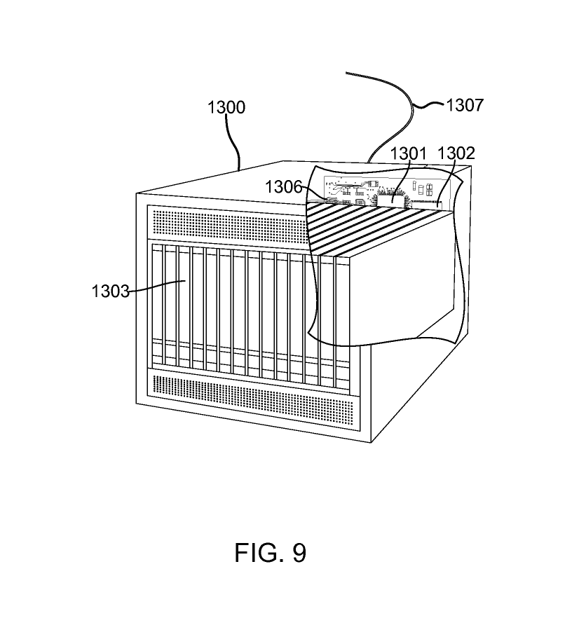

The various embodiments may also be implemented on any of a variety of commercially available server devices, such as the server 1300 illustrated in FIG. 9. Such a server 1300 typically includes a processor 1301 coupled to volatile memory 1302 and a large capacity nonvolatile memory, such as a disk drive 1303. The server 1300 may also include a floppy disc drive, compact disc (CD) or DVD disc drive coupled to the processor 1301. The server 1300 may also include network access ports 1306 coupled to the processor 1301 for establishing network interface connections with a network 1307, such as a local area network coupled to other broadcast system computers and servers, the Internet, the public switched telephone network, and/or a cellular data network (e.g., CDMA, TDMA, GSM, PCS, 3G, 4G, LTE, or any other type of cellular data network).

The processors 1002, 1102, 1202 and 1301 may be any programmable microprocessor, microcomputer or multiple processor chip or chips that can be configured by software instructions (applications) to perform a variety of functions, including the functions of the various embodiments described above. In some devices, multiple processors may be provided, such as one processor dedicated to wireless communication functions and one processor dedicated to running other applications. Typically, software applications may be stored in the internal memory 1004, 1104, 1106, 1212, and 1302 before they are accessed and loaded into the processors 1002, 1111, and 1201. The processors 1002, 1102, 1202 and 1301 may include internal memory sufficient to store the application software instructions. In many devices the internal memory may be a volatile or nonvolatile memory, such as flash memory, or a mixture of both. For the purposes of this description, a general reference to memory refers to memory accessible by the processors 1002, 1102, 1202 and 1301 including internal memory or removable memory plugged into the device and memory within the processor 1002, 1102, 1202 and 1301 themselves.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with various embodiments may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of communication devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm embodiment disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the aspects and/or embodiments shown herein but is to be accorded the widest scope consistent with the following claims and the principles and novel features disclosed herein.

What is claimed is:

1. A method of generating a point of interest profile of a target user, comprising:
querying a web site for at least one social comment associated with a point of interest visited by the target user, the at least one social comment posted to the web site by at least one third-party not affiliated with the point of interest;
parsing the at least one social comment for at least one keyword contained therein;
correlating the at least one keyword to an attribute characterizing visitors of the point of interest; and
generating a point of interest profile associating the attribute with the target user.

2. The method of claim 1, further comprising:
receiving an identifier for the point of interest in response to a mobile communication device associated with the target user being located within a designated proximity of the point of interest.

3. The method of claim 1, wherein the attribute is associated with the target user in response to the target user visiting the point of interest a plurality of times greater than a preselected threshold.

4. The method of claim 1, wherein the attribute is associated with the target user in response to the point of interest being one of a preselected quantity of locations most visited by the target user.

5. The method of claim 1, wherein the attribute is associated with the target user in response to receiving social comments from a threshold quantity of the at least one third-party.

6. The method of claim 1, wherein the attribute is at least one of a typical visitor's age, sex, income, marital status, hobby and entertainment interests.

7. The method of claim 1, wherein the point of interest profile includes an accuracy rating associated with the attribute based on a frequency the keyword is contained in the at least one social comment.

8. The method of claim 1, wherein the point of interest profile includes an accuracy level indicator for the attribute, the accuracy level indicator representing a statistical likelihood the attribute is correctly associated with the target user.

9. The method of claim 1, further comprising:
receiving a temporal indicator representing a time of day the target user visited the point of interest, wherein the at least one keyword is consistent with the temporal indicator.

10. The method of claim 1, further comprising:
determining a third-party attribute common to a plurality of the third-parties included in the at least one third party in connection with the point of interest, wherein the point of interest profile associates the third-party attribute with the target user.

11. A computing device comprising:
a memory; and
a processor coupled to the memory and configured with processor-executable instructions to perform operations comprising:
querying a web site for at least one social comment associated with a point of interest visited by a target user, the at least one social comment posted to the web site by at least one third-party not affiliated with the point of interest;
parsing the at least one social comment for at least one keyword contained therein;
correlating the at least one keyword to an attribute characterizing visitors of the point of interest; and
generating a point of interest profile associating the attribute with the target user.

12. The computing device of claim 11, wherein the processor is configured with processor-executable instructions to perform operations further comprising:
receiving an identifier for the point of interest in response to a mobile communication device associated with the target user being located within a designated proximity of the point of interest.

13. The computing device of claim 11, wherein the attribute is associated with the target user in response to the target user visiting the point of interest a plurality of times greater than a preselected threshold.

14. The computing device of claim 11, wherein the attribute is associated with the target user in response to the point of interest being one of a preselected quantity of locations most visited by the target user.

15. The computing device of claim 11, wherein the attribute is associated with the target user in response to receiving social comments from a threshold quantity of the at least one third-party.

16. The computing device of claim 11, wherein the attribute is at least one of a typical visitor's age, sex, income, marital status, hobby and entertainment interests.

17. The computing device of claim 11, wherein the point of interest profile includes an accuracy rating associated with the attribute based on a frequency the keyword is contained in the at least one social comment.

18. The computing device of claim 11, wherein the point of interest profile includes an accuracy level indicator for the attribute, the accuracy level indicator representing a statistical likelihood the attribute is correctly associated with the target user.

19. The computing device of claim 11, wherein the processor is configured with processor-executable instructions to perform operations further comprising:
receiving a temporal indicator representing a time of day the target user visited the point of interest, wherein the at least one keyword is consistent with the temporal indicator.

20. The computing device of claim 11, wherein the processor is configured with processor-executable instructions to perform operations further comprising:
determining a third-party attribute common to a plurality of the third-parties included in the at least one third party in connection with the point of interest, wherein the point of interest profile associates the third-party attribute with the target user.

21. A computing device for generating a point of interest profile of a target user, comprising:
means for querying a web site for at least one social comment associated with a point of interest visited by the target user, the at least one social comment posted to the web site by at least one third-party not affiliated with the point of interest;
means for parsing the at least one social comment for at least one keyword contained therein;
means for correlating the at least one keyword to an attribute characterizing visitors of the point of interest; and
means for generating a point of interest profile associating the attribute with the target user.

22. The computing device of claim 21, further comprising:
means for receiving an identifier for the point of interest in response to a mobile communication device associated with the target user being located within a designated proximity of the point of interest.

23. The computing device of claim 21, wherein the attribute is associated with the target user in response to the target user visiting the point of interest a plurality of times greater than a preselected threshold.

24. The computing device of claim 21, wherein the attribute is associated with the target user in response to the point of interest being one of a preselected quantity of locations most visited by the target user.

25. The computing device of claim 21, wherein the attribute is associated with the target user in response to receiving social comments from a threshold quantity of the at least one third-party.

26. The computing device of claim 21, wherein the attribute is at least one of a typical visitor's age, sex, income, marital status, hobby and entertainment interests.

27. The computing device of claim 21, wherein the point of interest profile includes an accuracy rating associated with the attribute based on a frequency the keyword is contained in the at least one social comment.

28. The computing device of claim 21, wherein the point of interest profile includes an accuracy level indicator for the attribute, the accuracy level indicator representing a statistical likelihood the attribute is correctly associated with the target user.

29. The computing device of claim 21, further comprising:
means for receiving a temporal indicator representing a time of day the target user visited the point of interest, wherein the at least one keyword is consistent with the temporal indicator.

30. The computing device of claim 21, further comprising:
means for determining a third-party attribute common to a plurality of the third-parties included in the at least one third party in connection with the point of interest, wherein the point of interest profile associates the third-party attribute with the target user.

31. A non-transitory computer readable storage medium having stored thereon processor-executable software instructions configured to cause a processor of a computing device to perform operations for generating a point of interest profile of a target user, the operations comprising:
querying a web site for at least one social comment associated with a point of interest visited by the target user, the at least one social comment posted to the web site by at least one third-party not affiliated with the point of interest;
parsing the at least one social comment for at least one keyword contained therein;
correlating the at least one keyword to an attribute characterizing visitors of the point of interest; and
generating a point of interest profile associating the attribute with the target user.

32. The non-transitory computer readable storage medium of claim 31, wherein the stored processor-executable instructions are configured to cause the processor of the computing device to perform operations further comprising:
receiving an identifier for the point of interest in response to a mobile communication device associated with the target user being located within a designated proximity of the point of interest.

33. The non-transitory computer readable storage medium of claim 31, wherein the stored processor-executable instructions are configured to cause the processor of the computing device to perform operations such that the attribute is associated with the target user in response to the target user visiting the point of interest a plurality of times greater than a preselected threshold.

34. The non-transitory computer readable storage medium of claim 31, wherein the stored processor-executable instructions are configured to cause the processor of the computing device to perform operations such that the attribute is associated with the target user in response to the point of interest being one of a preselected quantity of locations most visited by the target user.

35. The non-transitory computer readable storage medium of claim 31, wherein the stored processor-executable instructions are configured to cause the processor of the computing device to perform operations such that the attribute is associated with the target user in response to receiving social comments from a threshold quantity of the at least one third-party.

36. The non-transitory computer readable storage medium of claim 31, wherein the stored processor-executable instructions are configured to cause the processor of the computing device to perform operations such that the attribute is at least one of a typical visitor's age, sex, income, marital status, hobby and entertainment interests.

37. The non-transitory computer readable storage medium of claim 31, wherein the stored processor-executable instructions are configured to cause the processor of the computing device to perform operations such that the point of interest profile includes an accuracy rating associated with the attribute based on a frequency the keyword is contained in the at least one social comment.

38. The non-transitory computer readable storage medium of claim 31, wherein the stored processor-executable instructions are configured to cause the processor of the computing device to perform operations such that the point of interest profile includes an accuracy level indicator for the attribute, the accuracy level indicator representing a statistical likelihood the attribute is correctly associated with the target user.

39. The non-transitory computer readable storage medium of claim 31, wherein the stored processor-executable instructions are configured to cause the processor of the computing device to perform operations further comprising:
receiving a temporal indicator representing a time of day the target user visited the point of interest, wherein the at least one keyword is consistent with the temporal indicator.

40. The non-transitory computer readable storage medium of claim 31, wherein the stored processor-executable instructions are configured to cause the processor of the computing device to perform operations further comprising:
determining a third-party attribute common to a plurality of the third-parties included in the at least one third party in connection with the point of interest, wherein the point of interest profile associates the third-party attribute with the target user.

41. A method of generating a point of interest profile, the method comprising:
receiving an identifier indicating a point of interest visited by a target user;
determining a third-party attribute associated with at least one third-party and the point of interest, wherein the third-party is not affiliated with the point of interest; and
generating a point of interest profile associating the attribute with the target user.

42. The method of claim 41, wherein the attribute is associated with the target user in response to the target user visiting the point of interest a plurality of times greater than a preselected threshold.

43. The method of claim 41, wherein the attribute is associated with the target user in response to the point of interest being one of a preselected quantity of locations most visited by the target user.

44. The method of claim 41, wherein the attribute is associated with the target user in response to a threshold quantity of third parties of the at least one third party having the attribute associated with them in connection with the point of interest.

45. The method of claim 41, wherein the attribute is at least one of a typical visitor's age, sex, income, marital status, hobby and entertainment interests.

46. The method of claim 41, wherein the point of interest profile includes an accuracy level indicator for the attribute, the accuracy level indicator representing a statistical likelihood the attribute is correctly associated with the target user.

47. The method of claim 41, further comprising:
receiving a temporal indicator representing a time of day the target user visited the point of interest, wherein the attribute is correlated to the temporal indicator.

48. A computing device comprising:
a memory; and
a processor coupled to the memory and configured with processor-executable instructions to perform operations comprising:
receiving an identifier indicating a point of interest visited by a target user;
determining a third-party attribute associated with at least one third-party and the point of interest, wherein the third-party is not affiliated with the point of interest; and
generating a point of interest profile associating the attribute with the target user.

49. The computing device of claim 48, wherein the attribute is associated with the target user in response to the target user visiting the point of interest a plurality of times greater than a preselected threshold.

50. The computing device of claim 48, wherein the attribute is associated with the target user in response to the point of interest being one of a preselected quantity of locations most visited by the target user.

51. The computing device of claim 48, wherein the attribute is associated with the target user in response to a threshold quantity of third parties of the at least one third party having the attribute associated with them in connection with the point of interest.

52. The computing device of claim 48, wherein the attribute is at least one of a typical visitor's age, sex, income, marital status, hobby and entertainment interests.

53. The computing device of claim 48, wherein the point of interest profile includes an accuracy level indicator for the attribute, the accuracy level indicator representing a statistical likelihood the attribute is correctly associated with the target user.

54. The computing device of claim 48, wherein the processor is configured with processor-executable instructions to perform operations further comprising:
receiving a temporal indicator representing a time of day the target user visited the point of interest, wherein the attribute is correlated to the temporal indicator.

55. A computing device for generating a point of interest profile comprising:
means for receiving an identifier indicating a point of interest visited by a target user;
means for determining a third-party attribute associated with at least one third-party and the point of interest, wherein the third-party is not affiliated with the point of interest; and
means for generating a point of interest profile associating the attribute with the target user.

56. The computing device of claim 55, wherein the attribute is associated with the target user in response to the target user visiting the point of interest a plurality of times greater than a preselected threshold.

57. The computing device of claim 55, wherein the attribute is associated with the target user in response to the point of interest being one of a preselected quantity of locations most visited by the target user.

58. The computing device of claim 55, wherein the attribute is associated with the target user in response to a threshold quantity of third parties of the at least one third party having the attribute associated with them in connection with the point of interest.

59. The computing device of claim 55, wherein the attribute is at least one of a typical visitor's age, sex, income, marital status, hobby and entertainment interests.

60. The computing device of claim 55, wherein the point of interest profile includes an accuracy level indicator for the attribute, the accuracy level indicator representing a statistical likelihood the attribute is correctly associated with the target user.

61. The computing device of claim 55, further comprising:
means for receiving a temporal indicator representing a time of day the target user visited the point of interest, wherein the attribute is correlated to the temporal indicator.

62. A non-transitory computer readable storage medium having stored thereon processor-executable software instructions configured to cause a processor of a computing device to perform operations for generating a point of interest profile, the operations comprising:
receiving an identifier indicating a point of interest visited by a target user;
determining a third-party attribute associated with at least one third-party and the point of interest, wherein the third-party is not affiliated with the point of interest; and
generating a point of interest profile associating the attribute with the target user.

63. The non-transitory computer readable storage medium of claim 62, wherein the stored processor-executable instructions are configured to cause the processor of the computing device to perform operations such that the attribute is associated with the target user in response to the target user visiting the point of interest a plurality of times greater than a preselected threshold.

64. The non-transitory computer readable storage medium of claim 62, wherein the stored processor-executable instructions are configured to cause the processor of the computing device to perform operations such that the attribute is associated with the target user in response to the point of interest being one of a preselected quantity of locations most visited by the target user.

65. The non-transitory computer readable storage medium of claim 62, wherein the stored processor-executable instructions are configured to cause the processor of the computing device to perform operations such that the attribute is associated with the target user in response to a threshold quantity of third parties of the at least one third party having the attribute associated with them in connection with the point of interest.

66. The non-transitory computer readable storage medium of claim 62, wherein the stored processor-executable instructions are configured to cause the processor of the computing device to perform operations such that the attribute is at least one of a typical visitor's age, sex, income, marital status, hobby and entertainment interests.

67. The non-transitory computer readable storage medium of claim 62, wherein the stored processor-executable instructions are configured to cause the processor of the computing device to perform operations such that the point of interest profile includes an accuracy level indicator for the attribute, the accuracy level indicator representing a statistical likelihood the attribute is correctly associated with the target user.

68. The non-transitory computer readable storage medium of claim 62, wherein the stored processor-executable instructions are configured to cause the processor of the computing device to perform operations further comprising:
receiving a temporal indicator representing a time of day the target user visited the point of interest, wherein the attribute is correlated to the temporal indicator.
